(19) United States
(12) Patent Application Publication
(10) Pub. No.: US 2025/0080566 A1
(43) Pub. Date: Mar. 6, 2025

(54) INFORMATION PROCESSING METHOD, INFORMATION PROCESSING SYSTEM, AND RECORDING MEDIUM

(71) Applicant: Panasonic Automotive Systems Co., Ltd., Kanagawa (JP)

(72) Inventors: Yuishi TORISAKI, Osaka (JP); Takamitsu SASAKI, Osaka (JP)

(73) Assignee: Panasonic Automotive Systems Co., Ltd., Kanagawa (JP)

(21) Appl. No.: 18/952,321

(22) Filed: Nov. 19, 2024

Related U.S. Application Data
(63) Continuation of application No. PCT/JP2023/003815, filed on Feb. 6, 2023.

(30) Foreign Application Priority Data
May 31, 2022 (JP) 2022-088286

(51) Int. Cl. H04L 9/40

(52) U.S. Cl. CPC H04L 63/1433; H04L 63/1425

(57) ABSTRACT

An information processing method is executed by an information processing system that analyzes an attack scenario by obtaining anomaly logs detected by mobile bodies. The method includes: obtaining, from a mobile body, an anomaly log indicating an anomaly of the mobile body; and when a detection detail of the anomaly included in the anomaly log and indicated by a first attack scenario does not match a detection detail of an anomaly indicated by any one of at least one second attack scenario that has been analyzed and matches a detection detail of an anomaly indicated by a third attack scenario among at least one third attack scenario that has not yet been analyzed, performing a process for the anomaly log as a first anomalous event occurring to the mobile body, after waiting until the third attack scenario has been analyzed.

### CROSS REFERENCE TO RELATED APPLICATIONS

This is a continuation application of PCT International Application No. PCT/JP2023/003815 filed on Feb. 6, 2023, designating the United States of America, which is based on and claims priority of Japanese Patent Application No. 2022-088286 filed on May 31, 2022.

### FIELD

The present disclosure relates to an information processing method, an information processing system, and a recording medium.

### BACKGROUND

Patent Literature (PTL) 1 discloses an automotive safety system that includes: a cyber watchman provided inside each of a plurality of vehicles; and a cyber hub provided outside the plurality of vehicles. The cyber watchman is connected to an in-vehicle communication network and obtains communication traffic data on the in-vehicle communication network. The cyber hub receives, via a communication network (such as the Internet), the communication traffic data obtained by the cyber watchman. This allows the cyber hub to collect the communication traffic data from the plurality of vehicles and obtain higher-order information used to resist a vehicle cyberattack.

### CITATION LIST

### Patent Literature

PTL 1: Japanese Patent No. 6382724

### SUMMARY

Information on an anomaly detected in a mobile body, such as a vehicle, is collected and then an analysis is performed on the anomaly detected in this mobile body. Here, it is desired that this analysis be performed efficiently. However, PTL 1 does not disclose an analysis method executed using such collected information.

In response to this, the present disclosure provides an information processing method, an information processing system, and a recording medium that enable an efficient analysis of an anomaly detected in a mobile body.

According to an aspect of the present disclosure, an information processing method executed by an information processing system that analyzes an attack scenario by obtaining anomaly logs detected by a plurality of mobile bodies includes: obtaining, from one mobile body among the plurality of mobile bodies, an anomaly log indicating an anomaly of the one mobile body; and when (i) a detection detail of the anomaly included in the anomaly log and indicated by a first attack scenario does not match a detection detail of an anomaly indicated by any one of at least one second attack scenario that has been analyzed and (ii) the detection detail of the anomaly indicated by the first attack scenario matches a detection detail of an anomaly indicated by a third attack scenario among at least one third attack scenario that has not yet been analyzed, performing a process for the anomaly log as a first anomalous event occurring to the one mobile body, after waiting until the third attack scenario has been analyzed.

According to another aspect of the present disclosure, an information processing system that analyzes an attack scenario by obtaining anomaly logs detected by a plurality of mobile bodies includes: an obtainer that obtains, from one mobile body among the plurality of mobile bodies, an anomaly log indicating an anomaly of the one mobile body; and a controller that performs, when (i) a detection detail of the anomaly included in the anomaly log and indicated by a first attack scenario does not match a detection detail of an anomaly indicated by any one of at least one second attack scenario that has already been analyzed and (ii) the detection detail of the anomaly indicated by the first attach scenario matches a detection detail of an anomaly indicated by a third attack scenario among at least one third attack scenario that has not yet been analyzed, a process for the anomaly log as a first anomalous event occurring to the one mobile body, after waiting until the third attack scenario has been analyzed.

According to still another aspect of the present disclosure, a non-transitory computer-readable recording medium has recorded thereon a program for causing a computer to execute the above-described information processing method.

### Advantageous Effects of Invention

According to an aspect of the present disclosure, the information processing method and so forth that enable an efficient analysis of an anomaly detected in a mobile body can be achieved.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a configuration of a mobile body supporting system according to Embodiment 1.

FIG. 2 is a block diagram illustrating a functional configuration of an information processing system according to Embodiment 1.

FIG. 3 is a diagram illustrating an example of an attack scenario list according to Embodiment 1.

FIG. 4 is a flowchart illustrating a determination operation performed by an information processing device according to Embodiment 1.

FIG. 5 is a diagram illustrating an example of a result of scenario determination according to Embodiment 1.

FIG. 6 is a flowchart illustrating an operation performed by the information processing device after an analysis result is received, according to Embodiment 1.

FIG. 7A is a diagram illustrating a first example of an analysis screen displayed by a display device according to Embodiment 1.

FIG. 7B is a diagram illustrating a second example of the analysis screen displayed by the display device according to Embodiment 1.

FIG. 7C is a diagram illustrating a third example of the analysis screen displayed by the display device according to Embodiment 1.

FIG. 7D is a diagram illustrating a fourth example of the analysis screen displayed by the display device according to Embodiment 1.

FIG. 7E is a diagram illustrating a fifth example of the analysis screen displayed by the display device according to Embodiment 1.

FIG. 8 is a flowchart illustrating an operation performed by an information processing device after an analysis result is received, according to Variation of Embodiment 1.

FIG. 9 is a block diagram illustrating a functional configuration of an information processing system according to Embodiment 2.

FIG. 10 is a flowchart illustrating an operation performed by an information processing device according to Embodiment 2.

FIG. 11 is a block diagram illustrating a functional configuration of an information processing system according to Embodiment 3.

FIG. 12 is a flowchart illustrating an operation performed by an information processing device according to Embodiment 3.

### DESCRIPTION OF EMBODIMENTS

### (Circumstances Leading to the Present Disclosure)

For a detected anomaly due to a cyberattack (hereafter, also simply referred to as an attack) against a mobile body, such as a vehicle, an anomaly analysis (attack analysis) is performed in an analysis center (a so-called security operation center (SOC)).

A result of the analysis performed on an attack that occurred in the past is registered as an attack scenario in a database of the analysis center. Moreover, a response method against this attack scenario is also registered. In the event of an anomaly (attack) detected in a mobile body, the analysis center determines whether a detection detail of an anomaly assumed in the analyzed attack scenario registered in the database match a detection detail of the anomaly actually detected in the mobile body. An attack scenario refers to a time-series scenario of an attack, and indicates: an attack procedure of the attack; and detection details of anomalies assumed to occur to the mobile body when the attack is made on the mobile body by this attack procedure. The detection details of the anomalies are time-series information on a plurality of anomalous parts and detection details of anomalies detected by an anomaly detector. This time-series information indicates: the parts where the anomalies occur; the kinds of the anomalies that occur; and the order in which the anomalies occur. In the present specification, a match between attack scenarios means that a detection detail of an anomaly included in an attack scenario matches a detection detail of an anomaly included in a comparison-target attack scenario or matches an anomaly detection result included in a series of anomaly logs.

Then, when the detection detail of the anomaly matches the already-analyzed attack scenario, the detected anomaly is determined to be caused by the attack that is the same as the past attack. Thus, a detailed analysis is not made and response to the attack is performed using a known response method. When the detection detail of the anomaly does not match any already-analyzed attack scenario, the detected anomaly may possibly be a new kind of attack. Thus, a detailed analysis is performed to promote study of response methods.

In the event of a new kind of attack made simultaneously on a plurality of mobile bodies, a detailed analysis is required. To respond to all the attacks simultaneously made, an enormous number of computational resources and an enormous number of human resources are required. For the simultaneous attacks of the same new kind, the analysis results of these attacks are identical. On this account, making the analyses of all the attacks is significantly inefficient.

In response to this, the present inventors have invented an information processing method and so forth described below by diligently studying the information processing method and so forth that enable an efficient analysis of an anomaly detected in a mobile body in the event of multiple attacks that are of the same new kind determined based on characteristics of the attack made on the mobile body. Note that examples of the characteristics of the attack made on the mobile body include: that the same attack is likely to made intensively in a limited period of time; and the same attack is highly likely to be simultaneously made particularly against multiple automobiles of the same type because of their consistency.

According to an aspect of the present disclosure, an information processing method executed by an information processing system that analyzes an attack scenario by obtaining anomaly logs detected by a plurality of mobile bodies includes: obtaining, from one mobile body among the plurality of mobile bodies, an anomaly log indicating an anomaly of the one mobile body; and when (i) a detection detail of the anomaly included in the anomaly log and indicated by a first attack scenario does not match a detection detail of an anomaly indicated by any one of at least one second attack scenario that has been analyzed and (ii) the detection detail of the anomaly indicated by the first attack scenario matches a detection detail of an anomaly indicated by a third attack scenario among at least one third attack scenario that has not yet been analyzed, performing a process for the anomaly log as a first anomalous event occurring to the one mobile body, after waiting until the third attack scenario has been analyzed.

With this, when the first attack scenario matches the anomaly detail indicated by the third attack scenario among the at least one third attack scenario that has not yet been analyzed, the process (the analysis, for example) for the first anomalous event is not executed until the end of the analysis of the matching third attack scenario. More specifically, redundant analyses of the same attack can be avoided. Thus, the information processing method according to the present embodiment enables an efficient analysis of the anomaly detected in the mobile body.

For example, it is possible that when an analysis result of analyzing the third attack scenario is obtained during the waiting, the performing includes, as the process, outputting the analysis result of the third attack scenario as an analysis result of the first anomalous event.

With this, the analysis result of this third attack scenario can also be used as the analysis result of the first anomalous event. Thus, the analysis can be made more efficiently as compared to when the analysis of the first anomalous event is actually made.

For example, it is possible that when an analysis result of analyzing the third attack scenario that matches the first attack scenario is obtained during the waiting, the performing includes, as the process, determining whether the detection detail of the anomaly indicated by the third attack scenario analyzed matches the detection detail of the anomaly included in the anomaly log.

With this, whether the first attack scenario is a new kind of attack can be determined more accurately. When the first attack scenario is not a new kind of attack, the first anomalous event is not analyzed. Thus, the analysis of the anomaly can be efficiently made.

For example, it is possible that when the detection detail of the anomaly indicated by the third attack scenario analyzed does not match the detection detail of the anomaly indicated by the first attack scenario, the performing includes determining whether the detection detail of the anomaly indicated by the first attack scenario matches a detection detail of an anomaly indicated by at least one of: at least one latest second attack scenario; or at least one latest third attack scenario.

With this, before the analysis result of the third attack scenario is obtained, at least one of whether an analysis result of an attack that is the same as the first attack scenario is obtained or whether an attack that is the same as the first attack scenario is registered as a third attack scenario can be determined. Thus, a redundant analysis of the anomalous event corresponding to the same attack scenario as the first attack scenario can be further avoided.

For example, it is possible that when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes determining that the first anomalous event is to be analyzed.

With this, when the first attack scenario is a new kind of attack, the analysis of the first anomalous event can be made. This allows the analysis to be more reliably made on the anomalous event that needs to be analyzed. Thus, the analysis of the anomaly detected in the mobile body can be efficiently made.

For example, it is possible that the at least one third attack scenario is listed in a provisional scenario list, and that when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes adding the first attack scenario to the provisional scenario list.

With this, when the provisional scenario list is used in the determining whether the first attack scenario matches the at least one third attack scenario, a redundant analysis is prevented from being performed on an anomalous event that corresponds to the attack scenario of the attack made after the occurrence of the first attack scenario and that corresponds to the same attack scenario as the first attack scenario. Thus, the analysis of the anomaly detected in the mobile body can be made more efficiently.

For example, it is possible that when the first attack scenario matches a second attack scenario among the at least one second attack scenario, the performing includes outputting an analysis result of the second attack scenario as an analysis result of the first anomalous event.

With this, when the first attack scenario is a known attack, a past analysis result is used. This can avoid a redundant analysis of the first anomalous event. Thus, the analysis of the anomaly detected in the mobile body can be made more efficiently.

For example, it is possible that the information processing method further includes: determining a vehicle type of the one mobile body, based on the anomaly log, wherein in the performing, whether the first attack scenario matches any one of the at least one second attack scenario and whether the first attack scenario matches any one of the at least one third attack scenario are determined based on a result obtained in the determining of the vehicle type.

With this, the determination can be made according to the vehicle type. Thus, each determination can be made efficiently.

For example, it is possible that each of the at least one second attack scenario and the at least one third attack scenario is an attack scenario against a vehicle that is of a same vehicle type as the vehicle type of the one mobile body among the plurality of mobile bodies.

With this, the determination can be made faster as compared to when the determination is made using the second attack scenarios and the third attack scenarios corresponding to all vehicle types. Thus, the analysis can be made efficiently in term of reducing the time required for the determination.

For example, it is possible that the at least one second attack scenario and the at least one third attack scenario are listed in a combined scenario list, and that either the at least one second attack scenario or the at least one third attack scenario includes a flag.

With this, whether the first attack scenario matches the second attack scenario and whether the first attack scenario matches the third attack scenario can be determined using the single combined scenario list. Thus, the determination process can be performed more efficiently than the determination process performed using a plurality of lists.

For example, it is possible that the detection detail of the anomaly indicated by the first attack scenario matches the detection detail of the anomaly indicated by any one of the at least one second attack scenario and whether the detection detail of the anomaly indicated by the first attack scenario matches the detection detail of the anomaly indicated by any one of the at least one third attack scenario are determined by a single determination using the combined scenario list.

With this, the process for the first anomalous event can be determined by the single determination process. Thus, the determination process can be performed efficiently.

For example, it is possible that in the performing, in a case where the at least one third attack scenario includes the flag, when the flag is added to an attack scenario that indicates a detection detail of an anomaly that matches the detection detail of the anomaly indicated by the first attack scenario, among the at least one second attack scenario and the at least one third attack scenario included in the combined scenario list, analyzing of the first anomalous event is performed after the waiting.

With this, when the flag is added to the attack scenario that matches the first attack scenario, the first attack scenario is caused to wait. More specifically, by a simple determination whether the flag is present, the process to be performed for the first anomalous event can be determined. Thus, the determination process can be performed efficiently.

For example, it is possible that the performing includes: adding, to a waiting list, the first anomalous event for which the performing of the process is to be waited; and presenting presentation information based on the waiting list.

With this, the analyzer is able to analyze the attack scenario by reference to the presentation information. More specifically, the analysis efficiency of the analyzer can be increased.

For example, it is possible that the presentation information includes information indicating, out of a plurality of the first anomalous events included in the waiting list, a total number of first anomalous events determined to match the detection detail of the anomaly included in the at least one third attack scenario.

With this, for a plurality of attack scenarios targeted for analysis, the analyzer is able to conduct study, such as assigning priorities to the attack scenarios targeted for analysis, using the presentation information. More specifically, the analysis efficiency of the analyzer can be increased.

For example, it is possible that when an analysis result of a second anomalous event that is a source for a fourth attack scenario included among the at least one third attack scenario is outputted, the performing includes outputting a total number of anomalous events determined to match a detection detail of an anomaly indicated by the fourth attack scenario when whether the first attack scenario matches any one of the at least one third attack scenario is determined.

With this, the total number of waiting anomalous events determined to match the detection detail of the anomaly indicated by the fourth attack scenario is outputted together with the detection detail of the anomaly indicated by the fourth attack scenario. This can increase the analysis efficiency of the analyzer.

For example, it is possible that the information processing method further includes: determining whether an analysis of an anomalous event that is a source for the third attack scenario indicating the anomaly detail matching the first attack scenario is completed.

With this, the processes from obtaining the anomaly log to outputting the analysis result by the information processing method can be performed as a sequence of processes.

According to another aspect of the present disclosure, an information processing system that analyzes an attack scenario by obtaining anomaly logs detected by a plurality of mobile bodies includes: an obtainer that obtains, from one mobile body among the plurality of mobile bodies, an anomaly log indicating an anomaly of the one mobile body; and a controller that performs, when (i) a detection detail of the anomaly included in the anomaly log and indicated by a first attack scenario does not match a detection detail of an anomaly indicated by any one of at least one second attack scenario that has already been analyzed and (ii) the detection detail of the anomaly indicated by the first attach scenario matches a detection detail of an anomaly indicated by a third attack scenario among at least one third attack scenario that has not yet been analyzed, a process for the anomaly log as a first anomalous event occurring to the one mobile body, after waiting until the third attack scenario has been analyzed. According to still another aspect of the present disclosure, a non-transitory computer-readable recording medium has recorded thereon a program for causing a computer to execute the above-described information processing method.

With this, the same advantageous effect as those of the information processing method described above can be achieved.

General or specific aspects of the present disclosure may be implemented to a system, a device, a method, an integrated circuit, a computer program, a non-transitory computer-readable recording medium such as a Compact Disc-Read Only Memory (CD-ROM), or any given combination thereof. The program may be stored in the recording medium, or provided to the recording medium via a wide area network such as the Internet.

Hereinafter, certain exemplary embodiments will be described in detail with reference to the accompanying Drawings.

The following embodiments are generic and specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should also be noted that the following description may include a word indicating a relationship between elements, such as “the same” or “identical”, and numerical values and numerical value ranges. However, they do not mean exact meanings only. They also mean the substantially same ranges including a difference of, for example, about several % (or about 10%) from the completely same range.

### Embodiment 1

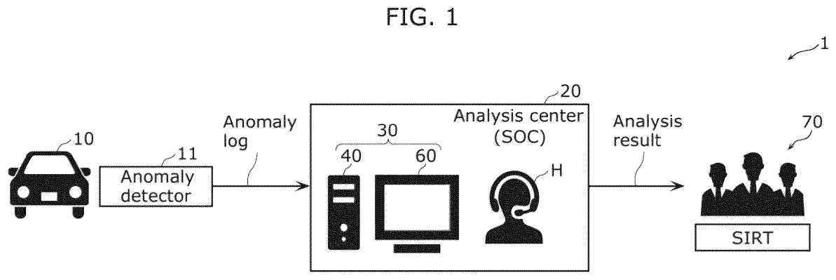

The following describes an information processing system according to the present embodiment with reference to FIG. 1 to FIG. 7E.

### [1-1. Configuration of Mobile Body Supporting System]

A configuration of a mobile body supporting system including an information processing system according to the present embodiment is described with reference to FIG. 1. FIG. 1 is a schematic diagram illustrating a configuration of mobile body supporting system 1 according to the present embodiment.

As illustrated in FIG. 1, mobile body supporting system 1 includes vehicle 10, analysis center 20, and security incident response team (SIRT) server 70. Mobile body supporting system 1 is an information processing system including: analysis center 20 that analyzes an anomaly detected in vehicle 10; and SIRT server 70 (or a manager of SIRT server 70) that responds to the anomaly. For example, mobile body supporting system 1 is the information processing system for analyzing an attack scenario by obtaining anomaly logs detected in a plurality of vehicles 10. Note that vehicle need not be included in mobile body supporting system 1.

Vehicle 10 is a mobile body targeted for an anomaly analysis and an anomaly response for instance performed by mobile body supporting system 1. Vehicle 10 is wirelessly communicatively connected to an external device (such as an external server). Examples of vehicle 10 include, but not limited to, an autonomous vehicle. The number of vehicles 10 included in mobile body supporting system 1 is two or more and is not limited to any particular number.

Vehicle 10 includes anomaly detector 11. Although not illustrated in the drawing, vehicle 10 includes a plurality of in-vehicle devices. The plurality of in-vehicle devices include: at least one electronic control unit (ECU) that controls, for example, travel of vehicle 10; an in-vehicle infotainment (IVI); and a telematics control unit (TCU) (telematics communication unit). These in-vehicle devices are connected to each other via an in-vehicle network.

Anomaly detector 11 detects that an anomaly occurs to vehicle 10. For example, anomaly detector 11 may be provided for each of the at least one ECU, the IVI, and the TCU, or may be provided to detect anomalies of at least two among the at least one ECU, the IVI, and the TCU. Anomaly detector 11 may perform a measurement of a control target of a corresponding in-vehicle device (may measure the speed, acceleration, or steering angle, for example) and detect an anomaly based on the measurement result. Furthermore, anomaly detector 11 may detect an anomaly when a control signal transmitted to an in-vehicle device targeted for monitoring includes a signal that causes vehicle 10 to perform an anomalous operation. The detection method used by anomaly detector 11 to detect an anomaly is not limited to any particular method.

Anomaly detector 11 detects: an anomalous part (also referred to as an attacked part) in which vehicle 10 has an anomaly; and an anomaly detail (also referred to as a detection detail). Then, anomaly detector 11 transmits, to analysis center 20, an anomaly log including time-series data on anomalous parts and anomaly details. In addition to the time-series data on the anomalous parts and the anomaly details, the anomaly log may include information on the manufacturer (vehicle manufacturer) of vehicle 10, the vehicle type of vehicle 10, the time of day at which the anomaly was detected, and the location where the anomaly was detected, for example.

Examples of the type of attack detected by anomaly detector 11 include, but not limited to, “port scan”, “buffer overflow”, “denial of service (DOS) attack”, “unauthorized access”, “firmware (FW) unauthorized update”, “unauthorized communication (unusual communication)”, “invalid command”, and “memory access error”. “Unauthorized communication” also includes transmission of an anomalous command.

Analysis center 20 obtains the anomaly log from vehicle 10 and processes the anomaly log as an anomalous event. Analysis center has a function of transmitting, to SIRT server 70, an analysis result of the anomaly log as an analysis result of the anomalous event. Analysis center 20 is also referred to as a security operation center (SOC). Analysis center 20 includes information processing system 30. Furthermore, analyzer H that analyzes the anomaly log is placed in analysis center 20. Note that the analysis result may be transmitted to SIRT server 70, or may be distributed to concerned personnel by email for example. Alternatively, a person in charge of the SIRT may obtain the analysis result by accessing analysis center 20.

Examples of the analysis described here include determining, based on vehicle information on vehicle 10 (such as results of sensing by various sensors and communication logs) and a version of software used in vehicle 10: whether there is an association between an anomalous part and an anomaly detail included in the time-series data on the anomalous parts and the anomaly details included in the anomaly log of vehicle 10; whether each of the anomalous parts and the anomaly details is caused by an attack; and whether the anomalous parts and the anomaly details are caused by a single series of attacks or by separate attacks. The analysis result includes information indicating the time-series data on the anomalous parts and the anomaly details caused by related attacks (a series of attacks). Note that the analysis result may be indicated by a name or an ID of an attack scenario.

Note that the analysis need not be performed by analyzer H (person) and may be performed by a computer.

Information processing system 30 is an analysis system that analyzes an anomaly detected in vehicle 10. Information processing system 30 includes information processing device 40 and display device 60.

Information processing device 40 is a server (SOC server) included in analysis center 20, and performs information processing for analyzing an anomaly detected in a corresponding one of the plurality of vehicles 10. Moreover, information processing device 40 causes display device 60 to display information for analyzing an anomaly log. Anomaly logs assumed to be caused by the same attack made on a single vehicle are processed together as a series of anomaly logs. A series of anomalous events that occurred is treated as a single anomalous event. Note that the anomaly logs assumed to be caused by the same attack refer to a set of anomaly logs of the anomalies detected in the single vehicle within a certain period of time.

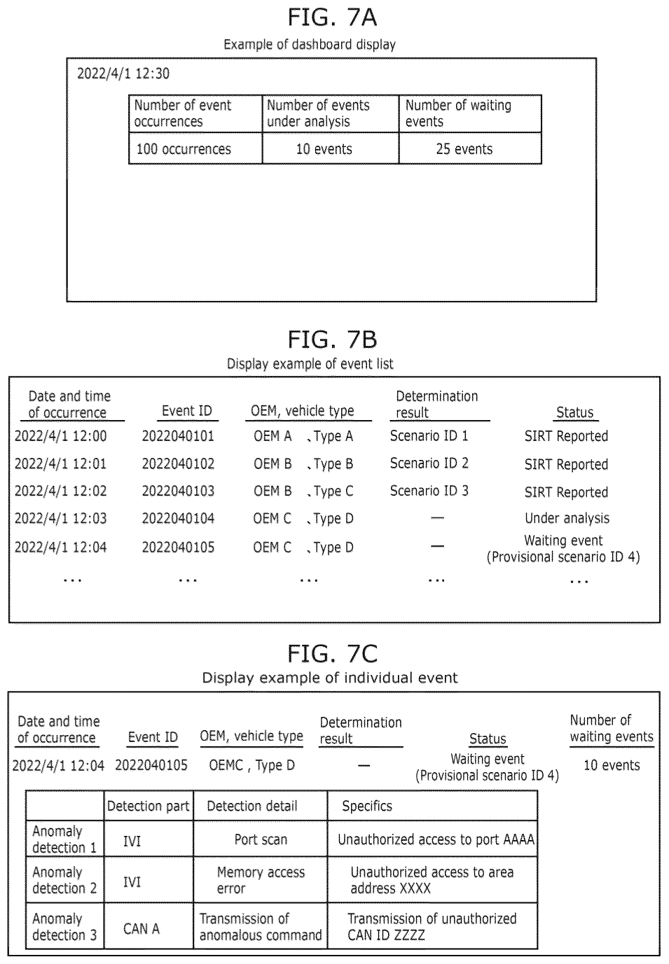

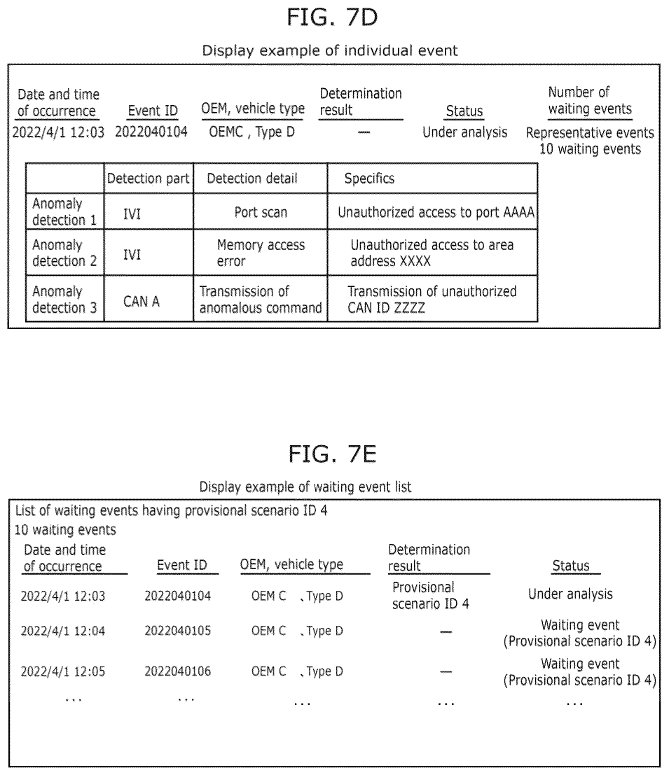

Display device 60 displays, to analyzer H, information for analyzing an anomalous event. Items displayed by display device 60 are described later with reference to FIG. 7A to FIG. 7E. Display device 60 may be a liquid crystal display device, for example. Note that, in place of or in addition to display device 60, information processing system 30 may include a device for presenting the information for analysis by, for example, sound or light. Display device 60 is an example of a presentation device.

SIRT server 70 is owned by an organization, such as a SIRT, that makes security response. In the event of an anomaly caused to vehicle 10 by an attack (a security incident), such as hacking, SIRT server 70 obtains information on this anomaly via analysis center 20.

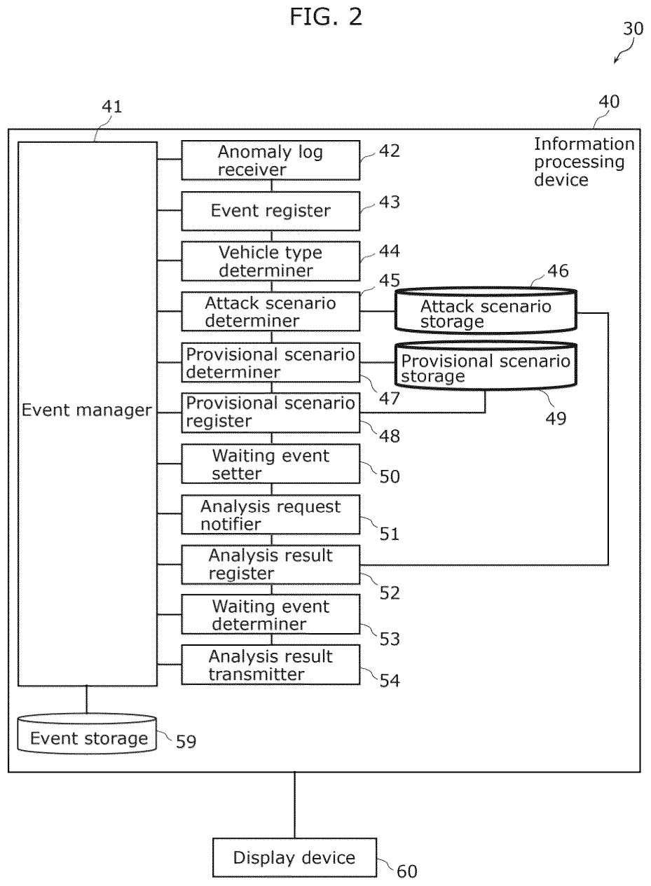

Next, the configuration of information processing system 30 is further described with reference to FIG. 2. FIG. 2 is a block diagram illustrating a functional configuration of information processing system 30 according to the present embodiment.

As illustrated in FIG. 2, information processing device 40 included in information processing system 30 performs a process for transmitting, to SIRT server 70, the analysis result of the anomalous event, based on the anomaly log obtained from vehicle 10. Information processing device 40 includes event manager 41, anomaly log receiver 42, event register 43, vehicle type determiner 44, attack scenario determiner 45, attack scenario storage 46, provisional scenario determiner 47, provisional scenario register 48, provisional scenario storage 49, waiting event setter 50, analysis request notifier 51, analysis result register 52, waiting event determiner 53, analysis result transmitter 54, and event storage 59. Information processing device 40 is implemented by a microcontroller (or more specifically, an integrated circuit (IC) including a processor and a memory). Each of functions of information processing device is achieved by the processor executing a computer program stored in the memory.

Note that a detection detail of an anomaly determined from an anomaly log received by anomaly log receiver 42 is also referred to as a first attack scenario in the following description. Moreover, an attack scenario that has been analyzed to have caused an anomaly in an analyzed anomalous event and that is stored in attack scenario storage 46 is also referred to as a second attack scenario. Furthermore, an attack scenario based on an anomalous event that is stored in provisional scenario storage 49 and targeted for analysis is also referred to as a third attack scenario or a provisional scenario. Note that each of the first attack scenario and the third attack scenario is determined from an anomalous event that is not yet analyzed and that may not be caused by an attack. Note that, in addition to the analysis result of the analyzed anomalous event, the second attack scenario may also include: an attack scenario generated from a result of desk analysis based on threat information or vulnerability information; and an attack scenario generated by customizing, to suit the present vehicle manufacturer or the present vehicle type, an analysis result of an anomalous event that occurred to a vehicle of a different type or of a different vehicle manufacturer.

Event manager 41 is a control device that controls structural components included in information processing device 40. When anomaly log receiver 42 receives an anomaly log, event manager 41 manages the anomaly log as an anomalous event, and performs control to cause the structural components to made their respective determinations for example. Furthermore, event manager 41 manages the anomalous event and an attack scenario corresponding to this anomalous event.

Anomaly log receiver 42 receives an anomaly log indicating an anomaly detected by anomaly detector 11 of vehicle 10, via wireless communication using a communication network, such as the Internet. Anomaly log receiver 42 includes a wireless communication circuit (a wireless communication module). The anomaly log is a candidate for analysis made in analysis center 20.

When anomaly log receiver 42 receives an anomaly log, event register 43 issues anomalous event ID and then registers, in event storage 59, the occurrence of an anomaly (event) in vehicle 10 as an anomalous event. Event storage 59 stores a list that includes the anomalous event ID, the anomaly log, and an attack scenario ID corresponding to the anomalous event.

Vehicle type determiner 44 determines, based on the anomaly log that is the analysis candidate, the vehicle type of vehicle 10 to which the anomaly occurred. Here, the anomaly log includes information indicating the vehicle type (identification information on vehicle 10, for example). Thus, vehicle type determiner 44 may determine the vehicle type of vehicle 10, based on the information indicating the vehicle type. For example, when the anomaly log includes a vehicle identification number (VIN), vehicle type determiner 44 may determine the vehicle type by querying an associated system that manages VINs to find the vehicle type corresponding to the present VIN. The vehicle type may be the proper name (vehicle name) or the model code of vehicle 10. The vehicle type may also include information indicating the manufacturer of vehicle 10 or the model year of vehicle 10. The vehicle type may also include information on the destination or the manufacturing plant of the present vehicle. Furthermore, the vehicle type may also include the body type of vehicle 10, such as sedan or minivan.

Based on the anomaly log received by anomaly log receiver 42, attack scenario determiner 45 determines whether the first attack scenario indicating the detection detail of the anomaly detected in vehicle 10 matches the detection detail of the anomaly indicated by the second attack scenario that is an analyzed attack scenario. Attack scenario determiner 45 reads an attack scenario list including at least one second attack scenario from attack scenario storage 46. Then, attack scenario determiner 45 determines whether the first attack scenario matches the detection detail of the anomaly indicated by any one of the at least one second attack scenario included in the read attack scenario list. Note that the “match” described here includes both partial match and exact match on the time-series data on the detection parts and the detection details of the anomalies between the first attack scenario and the second attack scenario.

Note that instead of reading the attack scenario list from attack scenario storage 46, attack scenario determiner 45 may read the second attack scenario from attack scenario storage 46 using a search criterion generated from the first attack scenario by attack scenario determiner 45 and then may make the determination of match between the first attack scenario and the second attack scenario. In this case, when attack scenario storage 46 does not store the second attack scenario that satisfies the aforementioned search criterion, it may be determined that the first attack scenario does not match any second attack scenario.

Note that, in the present specification, when a detection detail of an anomaly indicated by one attack scenario matches a detection detail of an anomaly indicated by another attack scenario, this also means that this one attack scenario matches this other attack scenario.

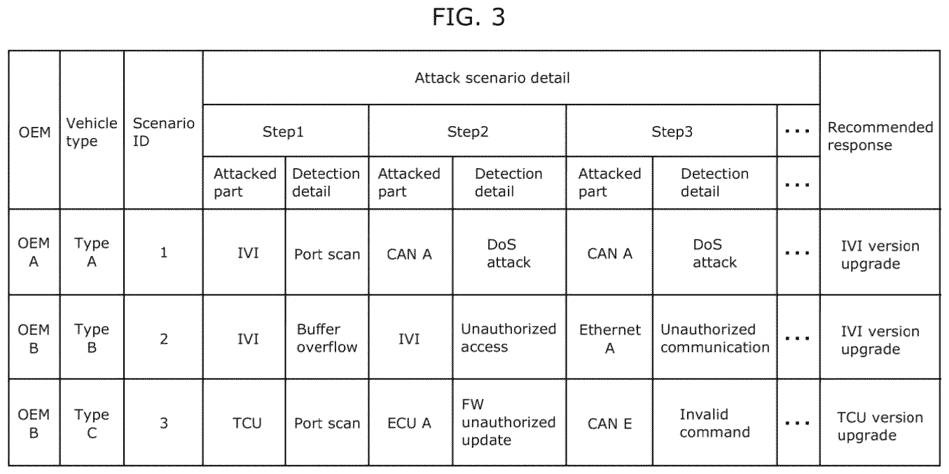

Attack scenario storage 46 is a storage device that stores the at least one second attack scenario. Attack scenario storage 46 stores an attack scenario list of the at least one second attack scenario. FIG. 3 is a diagram illustrating an example of the attack scenario list according to the present embodiment.

As illustrated in FIG. 3, the attack scenario list includes items of original equipment manufacturer (OEM), vehicle type, scenario ID, attack scenario detail, and recommended response. Note that the attack scenario list may include at least the attack scenario detail as an item.

The OEM indicates identification information on a vehicle manufacturer. Because vehicle requirement specifications are different for each vehicle manufacturer, the possibility of an anomaly caused by an attack or the level of impact on the vehicle in the event of an anomaly may be different for each vehicle manufacturer. For this reason, the attack scenario list may include the identification information on the vehicle manufacturer. Note that the OEM may also include information on a manufacturing contractor.

The vehicle type indicates the type of a corresponding vehicle.

The scenario ID indicates identification information for identifying an attack scenario. The attack scenario list illustrated as an example in FIG. 3 includes three second attack scenarios having respective attack scenario IDs 1, 2, and 3.

The attack scenario detail includes a plurality of steps. As illustrated, anomalies are detected in order of the plurality of steps. The example in FIG. 3 illustrates that the anomalies are detected in the vehicle in order of “Step 1”, “Step 2”, and “Step 3”. Each of the steps includes information in which an attacked part is associated with a detection detail of the anomaly caused by this attack or an assumed detection detail of the anomaly caused by this attack. For example, in the attack scenario having the attack scenario ID “1”, the detection of an anomaly as a port scan in the IVI is followed by the detection of a DOS attack in control area network (CAN) A that is next followed by the detection of another DOS attack in CAN A. Note that the attack scenario detail may also include an attack method. Furthermore, the attack scenario detail may also include a more specific detection detail, such as detection related to a specific CAN ID or IP address.

Note that the number of steps included in one attack scenario is not limited to any particular number, and may be different for each attack scenario.

The recommended response indicates a response method in the event of an attack scenario. For example, the response method executed by SIRT server 70 based on the analysis result may be included as the recommended response. Note that, instead of a specific response method, a response method ID indicating the specific response method may be included.

Furthermore, the attack scenario list may also include, for each attack scenario, information indicating the level of impact of the attack scenario on the vehicle. Moreover, the attack scenario list illustrated in FIG. 3 may be accessible or updatable by SIRT server 70, for example. Note that the attack scenario list need not include all of the items described above.

Attack scenario storage 46 is implemented by a semiconductor memory, for example. However, this is not intended to be limiting.

Referring back to FIG. 2, when attack scenario determiner 45 determines that the first attack scenario does not match the detection detail of the anomaly indicated by any one of the at least one second attack scenario, provisional scenario determiner 47 determines whether the first attack scenario matches any one of at least one third attack scenario that indicates a detection detail of an anomaly in an anomalous event targeted for analysis. Provisional scenario determiner 47 reads a provisional scenario list including the at least one third attack scenario from provisional scenario storage 49. Then, provisional scenario determiner 47 determines whether the first attack scenario matches the detection detail of the anomaly indicated by any one of the at least one third attack scenario included in the read provisional scenario list. Note that the “match” described here includes both partial match and exact match on the time-series data on the detection parts and the detection details of the anomalies between the first attack scenario and the second attack scenario.

Note that instead of reading the provisional scenario list from provisional scenario storage 49, provisional scenario determiner 47 may read the third attack scenario from provisional scenario storage 49 using a search criterion generated from the first attack scenario by provisional scenario determiner 47 and then may make the determination of match between the first attack scenario and the third attack scenario. In this case, when provisional scenario storage 49 does not store the third attack scenario that satisfies the aforementioned search criterion, it may be determined that the first attack scenario does not match any third attack scenario.

When the first attack scenario does not match the detection detail of the anomaly indicated by any one of the at least one third attack scenario, provisional scenario register 48 additionally registers this first attack scenario in the provisional scenario list. Provisional scenario register 48 has a function of updating the provisional scenario list based on the results of the determinations made by attack scenario determiner 45 and provisional scenario determiner 47. As a result, the provisional scenario list includes the first attack scenario that does not match either the at least one second attack scenario or the at least one third attack scenario.

Provisional scenario storage 49 is a storage device that stores the at least one third attack scenario. Provisional scenario storage 49 stores the provisional scenario list of the at least one third attack scenario. The provisional scenario list is a list of attack scenarios each indicating a detection detail of an anomaly in an anomalous event targeted for analysis. The anomalous events targeted for analysis include an anomalous event that is currently under analysis and an anomalous event that is waiting to be analyzed. The provisional scenario list does not include an attack scenario that indicates a detection detail of an anomaly in an anomalous event that has been analyzed. The provisional scenario list includes at least the item of the attack scenario detail, among the items included in the attack scenario list illustrated in FIG. 3. The provisional scenario list may also include the items of the vehicle manufacturer and the vehicle type, for example. Furthermore, the provisional scenario list may include a scenario ID (identification information) for identifying a corresponding one of the at least one third attack scenario. This scenario ID is different from the scenario ID illustrated in FIG. 3.

Provisional scenario storage 49 is implemented by a semiconductor memory, for example. However, this is not intended to be limiting.

When provisional scenario determiner 47 determines that the first attack scenario matches the detection detail of the anomaly indicated by one of the at least one third attack scenario, waiting event setter 50 sets, as a waiting event, this anomalous event indicating the detection detail of the anomaly in the first attack scenario. Here, the waiting event refers to an event that is caused to be in a wait state until the end of the analysis of the third attack scenario matching the first attack scenario. Waiting event setter 50 adds this anomalous event to a waiting list of waiting events, for example. Waiting event setter 50 may add, to the waiting list, information (such as the scenario ID of the third attack scenario) for identifying this third attack scenario determined to match the first attack scenario, in association with the anomalous event ID of this anomalous event.

The waiting list includes an item of an anomalous event ID of an anomalous event and an item of a scenario ID of a third attack scenario determined to match the first attack scenario indicating the detection detail of the anomaly in this anomalous event. Note that the waiting list may also include items of: the detail of the first attack scenario indicating the detection detail of the anomaly in this anomalous event; the vehicle manufacturer; and the vehicle type, for example.

With this, when the anomalous event having the same detection detail of the anomaly as the first attack scenario is under analysis or waiting to be analyzed, the start of the process performed for this anomalous event can be delayed until the end of the analysis of the anomalous event indicating the detection detail of the anomaly in the third attack scenario that matches the first attack scenario. More specifically, the process performed for the anomalous event indicating the detection detail of the anomaly in the first attack scenario can be suspended.

When provisional scenario determiner 47 determines that the first attack scenario does not match the detection detail of the anomaly indicated by any one of the at least one third attack scenario, provisional scenario register 48 registers this first attack scenario in the provisional scenario list. After this, because this anomalous event requires an analysis, analysis request notifier 51 notifies analyzer H of an analysis request. For example, analysis request notifier 51 may transmit the analysis request to an information terminal owned by analyzer H or cause display device 60 to display information indicating the analysis request. Note that examples of the information terminal include, but not limited to, a mobile information terminal, such as a smartphone or a tablet. The information terminal may be a stationary information terminal.

Analysis result register 52 obtains the analysis result of the anomalous event from analyzer H and registers the obtained analysis result. To be more specific, analysis result register 52 adds the attack scenario corresponding to the analysis result of the anomalous event to the attack scenario list. At this time, the first attack scenario corresponding to the anomalous event may be deleted from the provisional scenario list.

Waiting event determiner 53 determines whether the first attack scenario including the detection detail of the anomaly in the anomalous event that is included in the waiting list and that is determined to match the anomalous event corresponding to the third attack scenario having the registered analysis result matches the attack scenario having the registered analysis result. When the steps of the third attack scenario before the analysis are different from the steps of this third attack scenario included in the analysis result, waiting event determiner 53 may make a redetermination. When such a redetermination is not made, information processing device 40 need not include waiting event determiner 53.

Analysis result transmitter 54 transmits, to SIRT server 70, the analysis result obtained from analyzer H. Analysis result transmitter 54 includes a wireless communication circuit (a wireless communication module).

Event storage 59 stores a list including an anomalous event ID, an anomaly log, and an attack scenario ID corresponding to an anomalous event. Furthermore, event storage 59 may also store the waiting list. Event storage 59 is implemented by a semiconductor memory, for example. However, this is not intended to be limiting.

Note that, for information processing system 30 that supports a specific vehicle type, vehicle type determiner 44 need not be included.

### [1-2. Operation of Information Processing Device]

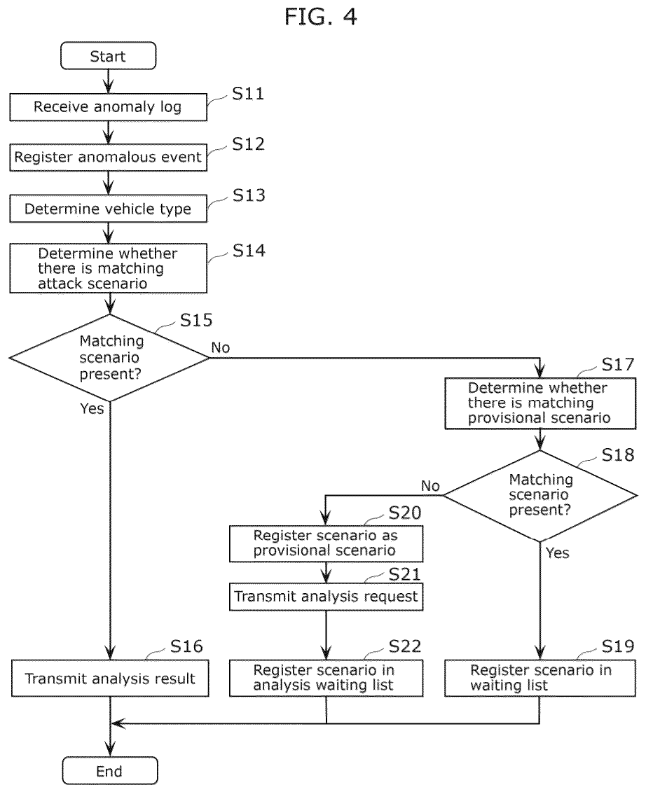

Next, an operation of information processing device 40 having the above configuration is described with reference to FIG. 4 to FIG. 6. FIG. 4 is a flowchart illustrating a determination operation (an information processing method) performed by information processing device 40 according to the present embodiment. Note that FIG. 4 illustrates the operation performed by information processing device that does not include waiting event determiner 53.

As illustrated in FIG. 4, anomaly log receiver 42 receives an anomaly log indicating an anomaly of vehicle 10 that is one of the plurality of vehicles, from this vehicle 10 or from a data server (not illustrated) that receives information on vehicle 10 (S11). Anomaly log receiver 42 obtains the anomaly log in Step S11. Anomaly log receiver 42 functions as an obtainer.

Next, event register 43 issues an anomaly log ID and registers the received anomaly log as an event in event storage 59 (S12).

Subsequent processes are performed for processing the anomaly log obtained from vehicle 10 as an anomalous event of vehicle 10.

Next, vehicle type determiner 44 determines the vehicle type of vehicle 10 that transmitted the anomaly log, based on the anomaly log received in Step S11 (S13). Vehicle type determiner 44 may associate the determined vehicle type with the anomaly log. Note that, for information processing system 30 that supports a specific vehicle type, Step S11 of determining the vehicle type may be omitted from the present operation.

Next, attack scenario determiner 45 determines whether the detection detail of the anomaly in the anomaly log (the first attack scenario) matches an attack scenario (the second attack scenario included in the attack scenario list) (S14). More specifically, attack scenario determiner 45 determines, based on the attack scenario list, whether the second attack scenario that matches the first attack scenario is present. Attack scenario determiner 45 functions as a determiner.

Attack scenario determiner 45 may extract, among the at least one second attack scenario included in the attack scenario list, the second attack scenario that matches at least one of the vehicle manufacturer of vehicle 10 or the vehicle type of vehicle 10. Then, attack scenario determiner 45 may determine whether the extracted second attack scenario matches the first attack scenario. For example, attack scenario determiner 45 may extract, among the at least one second attack scenario included in the attack scenario list, the second attack scenario that matches both the vehicle manufacturer of vehicle 10 and the vehicle type of vehicle 10. For example, the second attack scenario used in the determination made in Step S14 may be an attack scenario against a vehicle that is of the same vehicle type as the vehicle type of vehicle 10. Alternatively, this second attack scenario may be an attack scenario against a vehicle of a different type or may be an attack scenario generated by customizing the attack scenario against a vehicle of a different type. Alternatively, this second attack scenario may be an attack scenario generated by analyzer H from a result of desk study without using an anomaly log.

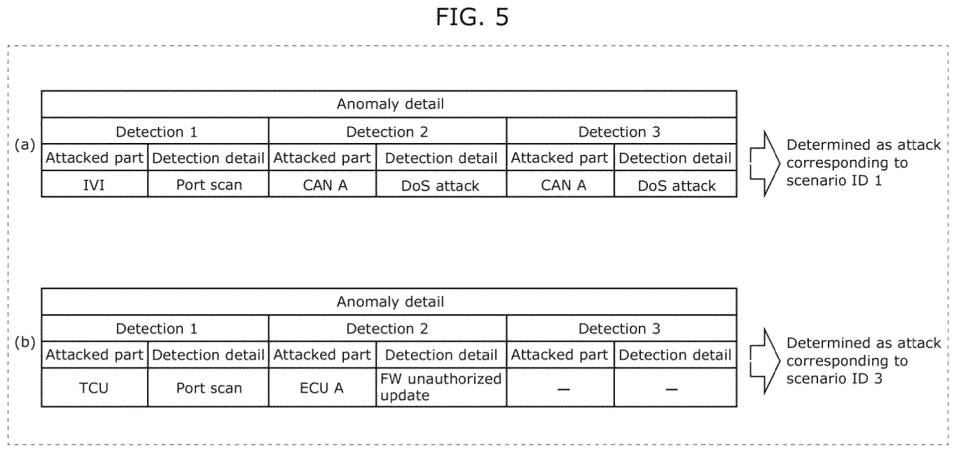

FIG. 5 is a diagram illustrating an example of a result of scenario determination according to the present embodiment. In (a) of FIG. 5, the determination results in an exact match. In (b) of FIG. 5, the determination results in a partial match. Note that Detection 1, Detection 2, and Detection 3 illustrated in each of (a) and (b) of FIG. 5 indicate the order of anomaly detections (the order of attacks). Detection 1, Detection 2, and Detection 3 correspond, respectively, to Step 1, Step 2, and Step 3 illustrated in FIG. 3.

In (a) of FIG. 5, Detection 1 indicating the detection detail of the anomaly log includes “IVI” as the attacked part and “Port scan” as the detection detail. Detection 2 includes “CAN A” as the attacked part and “DOS attack” as the detection detail. Detection 3 includes “CAN A” as the attacked part and “DOS attack” as the detection detail. The information indicated by the detection detail is an example of the first attack scenario.

Attack scenario determiner 45 determines that the detection detail illustrated in (a) of FIG. 5 exactly matches the second attack scenario having the scenario ID “1” among the at least one second scenario included in the attack scenario list illustrated in FIG. 3. To be more specific, attack scenario determiner 45 determines in Step S15 that, for the detection detail illustrated in (a) of FIG. 5, there is the second attack scenario that matches the first attack scenario. Attack scenario determiner 45 may associate the first attack scenario with scenario ID 1. Furthermore, attack scenario determiner 45 may also associate the first attack scenario with information indicating the exact match.

In (b) of FIG. 5, Detection 1 indicating the detection detail of the anomaly log includes “TCU (Telematics control unit)” as the attacked part and “Port scan” as the detection detail. Detection 2 includes “CAN A” as the attacked part and “FW unauthorized update” as the detection detail. The information indicated by the detection detail is an example of the first attack scenario.

Attack scenario determiner 45 determines that all the detection details illustrated in (b) of FIG. 5 partially match the second attack scenario having the scenario ID “3” among the at least one second scenario included in the attack scenario list illustrated in FIG. 3. To be more specific, attack scenario determiner 45 determines in Step S15 that, for the detection detail illustrated in (b) of FIG. 5, there is the second attack scenario that matches the first attack scenario. When the first attack scenario matches at least two steps of the plurality of steps included in the second attack scenario, attack scenario determiner 45 may determine that the first attack scenario partially matches the second attack scenario. Attack scenario determiner 45 may associate the first attack scenario with scenario ID 3. Furthermore, attack scenario determiner 45 may also associate the first attack scenario with information indicating the partial match.

Next, referring back to FIG. 4, when attack scenario determiner determines that there is the second attack scenario that matches the first attack scenario (Yes in S15), this means that the first attack scenario is a known attack. Thus, analysis result transmitter 54 transmits, to SIRT server 70, the analysis result of this second attack scenario as the analysis result of the anomalous event corresponding to this first attack scenario (S16).

When attack scenario determiner 45 determines that there is no second attack scenario that matches the first attack scenario (No in S15), provisional scenario determiner 47 determines whether the first attack scenario matches a provisional scenario (in the provisional scenario list) (S17). More specifically, provisional scenario determiner 47 determines, based on the provisional scenario list, whether the third attack scenario that matches the first attack scenario is present. Provisional scenario determiner 47 functions as a determiner.

Provisional scenario determiner 47 may extract, among the at least one third attack scenario included in the provisional scenario list, the third attack scenario that matches at least one of the OEM of vehicle 10 or the vehicle type of vehicle 10. Then, provisional scenario determiner 47 may determine whether the extracted third attack scenario matches the first attack scenario. For example, provisional scenario determiner 47 may extract, among the at least one third attack scenario included in the provisional scenario list, the third attack scenario that matches both the vehicle manufacturer of vehicle 10 and the vehicle type of vehicle 10. For example, the third attack scenario used in the determination made in Step S17 may be an attack scenario based on the anomaly log obtained from the vehicle that is of the same vehicle type as the vehicle type of vehicle 10.

Next, when provisional scenario determiner 47 determines that there is the third attack scenario that matches the first attack scenario (Yes in S18), this means that a similar event (a similar attack scenario) is targeted for analysis. Thus, to wait for the result of this analysis, waiting event setter 50 registers the anomalous event corresponding to the first attack scenario in the waiting list (S19). For the anomalous event registered in the waiting list, the analysis request is not transmitted and thus the analysis is not performed. More specifically, the process of Step S19 corresponds to causing this anomalous event to be postponed (waited) until the end of the analysis of the anomalous event corresponding to the third attack scenario. Note that waiting event setter 50 may attach, to the first attack scenario for which the result of the determination is “Yes” in Step S18, information indicating the waiting (wait state). Furthermore, waiting event setter 50 may attach the information indicating the waiting (wait state), to the information on this anomalous event stored in event storage 59.

As described above, when the first attack scenario indicating the detection detail of the anomaly of vehicle 10 does not match the detection detail of the anomaly indicated by any one of the at least one second attack scenario that has been analyzed and matches the detection detail of the anomaly indicated by one of the at least one third attack scenario that is targeted for an analysis, waiting event setter 50 causes execution of the process for the anomalous event corresponding to the first attack scenario to be in the wait state until the end of the analysis of this third attack scenario.

When provisional scenario determiner 47 determines that there is no third attack scenario that matches the first attack scenario (No in S18), provisional scenario register 48 determines that this first attack scenario indicates the detection detail of the anomaly in the anomalous event targeted for analysis and thus registers this first attack scenario as the provisional scenario (in the provisional scenario list) (S20). More specifically, when it is determined as “No” in Step S18, provisional scenario register 48 adds the first attack scenario to the provisional scenario list. Determining “No” in Step S18 corresponds to determining that the anomalous event is targeted for analysis.

With this, when anomaly log receiver 42 receives an anomaly log including the same detection detail of the anomaly as the first attack scenario from this time forward, information processing device is able to register this anomalous event in the waiting list. More specifically, when an anomaly indicating the same attack scenario as the first attack scenario is detected in another vehicle from this time forward, the analysis already performed on the anomalous event of the present vehicle can be prevented from being redundantly performed on this same anomalous event of this other vehicle.

Next, for an analysis of the anomalous event including the detection detail of the anomaly in the first attack scenario newly registered as a provisional scenario, analysis request notifier 51 transmits an analysis request to analyzer H (S21) and registers this anomalous event in an analysis waiting list (S22). Note that, in Step S22, analysis request notifier 51 may attach, to the first attack scenario for which the result of the determination is “No” in Step S18, information indicating the analysis-wait state.

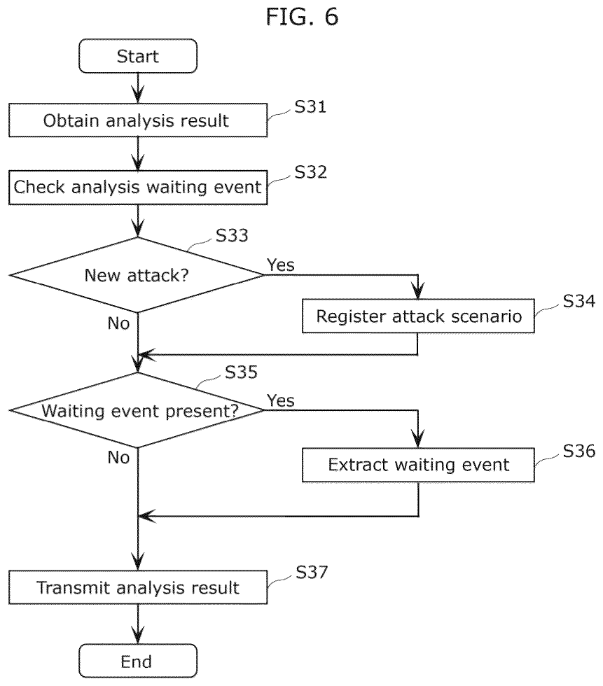

Next, an operation performed by information processing device when the analysis result is received during the wait state is described with reference to FIG. 6. FIG. 6 is a flowchart illustrating an operation (an information processing method) performed by information processing device 40 after the analysis result is received, according to the present embodiment. Note that, at the time when Step S31 is performed, the process for the anomalous event including the detection detail of the anomaly in the first attack scenario is in the wait state.

As illustrated in FIG. 6, analysis result register 52 obtains, from analyzer H, the analysis result of the anomalous event corresponding to the third attack scenario that matches the first attack scenario (S31). For example, analysis result register 52 obtains the analysis result via an operation performed by analyzer H on an operation section. For example, the operation section includes a keyboard, a mouse, and buttons, and may have a configuration to receive an operation by voice for instance.

Next, analysis result register 52 checks the analysis waiting list (S32). Analysis result register 52 establishes an association among the anomalous event registered in the analysis waiting list, the provisional scenario ID corresponding to the anomalous event, and the analysis result inputted in Step S31. Note that the association between the analysis result and the anomalous event may be established using the anomalous event ID inputted by analyzer H in Step S31. Alternatively, analyzer H may first select the corresponding scenario from a displayed waiting scenario list and then input the analysis result in Step S31.

Next, analysis result register 52 determines whether the attack scenario included in the obtained analysis result is a new attack (S33). Analysis result register 52 may determine whether the attack scenario included in the analysis result matches one of the at least one second attack scenario included in the attack scenario list.

Next, when determining that the attack scenario is a new attack (Yes in S33), analysis result register 52 registers this attack scenario in the attack scenario list (S34).

Next, after Step S34 or when it is determined as “No” in Step S33, analysis result transmitter 54 determines whether there is a waiting event corresponding to this analysis result (S35). Based on the waiting list, analysis result transmitter 54 determines whether there is an anomalous event caused to wait as having the same detection detail of the anomaly as the third attack scenario indicated by the provisional scenario ID associated with the analysis result in Step S32. Analysis result transmitter 54 may make the determination in Step S35 by determining whether the waiting list includes an anomalous event that corresponds to the first attack scenario corresponding to the scenario ID matching the provisional scenario ID associated with the analysis result.

Next, when determining that the waiting event is present (Yes in S35), analysis result transmitter 54 extracts this waiting event (S36). Then, analysis result transmitter 54 transmits the analysis result of the anomalous event and the analysis result obtained in Step S31 as the analysis result of this waiting event (S37). Analysis result transmitter 54 transmits (outputs) the analysis result obtained in Step S31 (the analysis result of the anomalous event corresponding to the third attack scenario) as the analysis result of the anomalous event caused to wait to be analyzed because this anomalous event is the same as the past anomalous event. Transmitting the analysis result obtained in Step S31 as the analysis result of the anomalous event corresponding to the first attack scenario is an example of the process performed for the anomalous event.

Note that the analysis result obtained as the analysis result of the waiting event may be transmitted together with information indicating that this result is the analysis result of the same attack. Moreover, information indicating that this anomalous event has been the waiting event may also be transmitted. Furthermore, the analysis result of the anomalous event corresponding to the analysis result obtained in Step S31 may also be transmitted together with information indicating that this result is the analysis result of the anomalous event corresponding to the attack scenario having the provisional scenario ID and information indicating the number of anomalous events that are waiting events as having this provisional scenario ID and the same detection detail of the anomaly.

When determining that no waiting event is present (No in S35), analysis result transmitter 54 transmits the analysis result obtained in Step S31 as the analysis result of the third attack scenario (S37).

### [1-3. Examples Displayed by Display Device]

Here, examples of a screen displayed by display device 60 to support the analysis made by analyzer H are described with reference to FIG. 7A to FIG. 7E. Each of FIG. 7A to FIG. 7E is a diagram illustrating an example of an analysis screen displayed by display device 60 according to the present embodiment. As illustrated in FIG. 7A to FIG. 7E, display device 60 displays presentation information based on the waiting list. Note that the presentation information includes the first attack scenario caused to be in the wait state.

FIG. 7A illustrates a display example of dashboard display. As illustrated in FIG. 7A, display device 60 may display, as the presentation information, “Number of event occurrences”, “Number of events under analysis”, and “Number of waiting events” that are included among the number of events processed by information processing system 30. Here, “Number of event occurrences” indicates a total number of occurrences of events (anomalies), and “Number of events under analysis” indicates the number of events that are currently being analyzed by analyzer H. Moreover, “Number of waiting events” indicates the number of events included in the current waiting list. Note that the number of event occurrences may be a total number of events in a fixed period of time or the sum of the number of waiting events and the number of events under analysis.

Note that the number of waiting events may indicate the number of anomalous events determined to match the same provisional scenario among the plurality of anomalous events included in the waiting list, for example. For example, when a plurality of anomalous events are determined to match a plurality of kinds of provisional scenario, the number of waiting events may be indicated for each kind of provisional scenario. Furthermore, the number of waiting events may include information indicating the number of anomalous events determined to match the detection detail of the anomaly included in at least one provisional scenario (at least one third attack scenario), among the plurality of anomalous events included in the waiting list.

FIG. 7B illustrates a display example of an event list including events. As illustrated in FIG. 7B, display device 60 may display, as the presentation information, “Date and time of occurrence”, “Event ID”, “OEM, vehicle type”, “Determination result”, and “Status” for each event. “Date and time of occurrence” indicates the date and time when the event (anomaly) occurs, and “Event ID” indicates the identification information for identifying this event. Moreover, “OEM, vehicle type” indicates the determination result of the OEM and the vehicle type. Furthermore, “Determination result” indicates the matching attack scenario as the result of the determination and includes the scenario ID of the attack scenario. Moreover, “Status” indicates the status of the analysis. For example, for the waiting event having the event ID 2022040105, information indicating that this event is currently in the wait state (that is, “Waiting event”) may be displayed. These pieces of information are managed by event manager 41 and stored in event storage 59.

Each of FIG. 7C and FIG. 7D is a display example of an individual event. As illustrated in FIG. 7C, display device 60 may display, as the presentation information for this event, “Date and time of occurrence”, “Event ID”, “OEM, vehicle type”, “Determination result”, “Status”, and “Number of waiting events”. An individual event (one event) includes detection details (Anomaly detections 1 to 3) corresponding to this event. The detection detail includes a detection part, a detection detail, and specifics of the detection detail. In FIG. 7C, “Number of waiting events” indicates the number of anomalous events determined to match the provisional scenario determined (as “Yes” in S18) to match the first attack scenario of the individual event illustrated in FIG. 7C. In this way, when outputting the analysis result of the anomalous event (an example of the second anomalous event) that is a source for one provisional scenario (an example of a fourth attack scenario) among the at least one provisional scenario, display device 60 may output (display) the number of anomalous events determined to match the detection detail of the anomaly indicated by the one provisional scenario together with the analysis result of this anomalous event when whether the first attack scenario matches any one of the at least one provisional scenario is determined.

In FIG. 7D, “Number of waiting events” further indicates that the individual event illustrated in FIG. 7D is a representative event targeted for analysis. Here, the representative event means that the anomalous event illustrated in FIG. 7D is determined as “No” in Step S18 and that the first attack scenario is registered as a provisional scenario (the third attack scenario).

FIG. 7E illustrates a display example of an event list including waiting events. As illustrated in FIG. 7E, display device 60 may display, as the presentation information, the same items as those in FIG. 7B. As an example, FIG. 7E illustrates that: the scenario ID of the provisional scenario having the event ID “2022040104” is “ID 4”; this event is under analysis; and events having different event IDs are waiting events.

The displayed screens as illustrated in FIG. 7A to 7E may help analyzer H assign priorities to the events targeted for analysis, for example.

### Variation of Embodiment 1

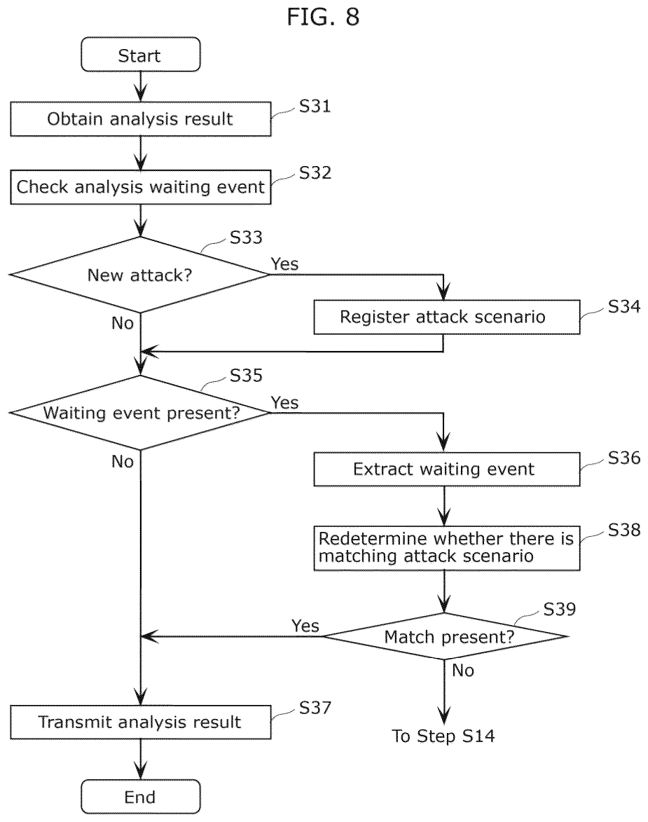

The above embodiment describes the operation performed by information processing device 40 including waiting event determiner 53 that does not operate in this operation. In contrast, the present variation describes an operation performed by information processing device 40 including waiting event determiner 53 that operates in this operation, with reference to FIG. 8. FIG. 8 is a flowchart illustrating an operation (an information processing method) performed by information processing device 40 after an analysis result is received, according to the present variation. Note that processes that are identical to those in FIG. 4 are assigned reference numerals identical to those used in FIG. 4, and thus descriptions thereof are omitted or simplified.

As illustrated in FIG. 8, waiting event determiner 53 redetermines whether the waiting event read in Step S36 matches the attack scenario (S38). Waiting event determiner 53 determines whether the detection detail of the anomaly in the event determined (as “Yes” in S18) to match the provisional scenario based on the anomalous event corresponding to the analysis result matches the attack scenario corresponding to the analysis result. For example, when the analysis result of the third attack scenario matching the first attack scenario is obtained, waiting event determiner 53 determines, as the process for the anomalous event, whether the detection detail of the anomaly indicated by this analyzed third attack scenario matches the detection detail of the anomaly included in the anomaly log. For example, waiting event determiner 53 determines whether the steps of the attack scenario corresponding to the analysis result included in the waiting event match the steps included in the analysis result.

For example, when it is determined that Detection 2 has no relations with Detections 1 and 3 as a result of the analysis of the attack scenario illustrated in (a) of FIG. 5, the analysis result of the attack scenario illustrated in (a) of FIG. 5 includes information indicating that Detections 1 and 3 are caused by a series of attacks. More specifically, even when the provisional scenario exactly matches the first attack scenario, the attack scenario based on the analysis result of the anomalous event corresponding to the provisional scenario may not match the first attack scenario. For this reason, the determination in Step S38 is made. Note that the determination made in Step S38 is an example of the process performed for the first attack scenario.

Next, when the result of the determination made by waiting event determiner 53 is positive (“Yes” in S39), analysis result transmitter 54 transmits the analysis result of the anomalous event corresponding to the provisional scenario and the analysis result obtained in Step S31 as the analysis result of the present waiting event (S37). Note that analysis result transmitter 54 may attach a degree of match determined by waiting event determiner 53 (in Step S38) to the analysis result of the present waiting event. When the result of the determination made by waiting event determiner 53 is negative (“No” in S39), analysis result transmitter 54 proceeds to Step S14 illustrated in FIG. 4. When the result of the determination is “No” in Step S39, this means that the waiting event and the attack event are caused by different attacks. Thus, the process for the waiting event is continued to be performed from Step S14 again.

This enables a determination to be made whether the first attack scenario matches at least one of: the at least one second attack scenario that may possibly have been updated during the wait state; or the at least one third attack scenario that may possibly have been updated during the wait state.

Note that the at least one second attack scenario that may possibly have been updated is an example of at least one latest second attack scenario. Moreover, the at least one third attack scenario that may possibly have been updated is an example of at least one latest third attack scenario. The latest attack scenario refers to an attack scenario updated most recently.

### Embodiment 2

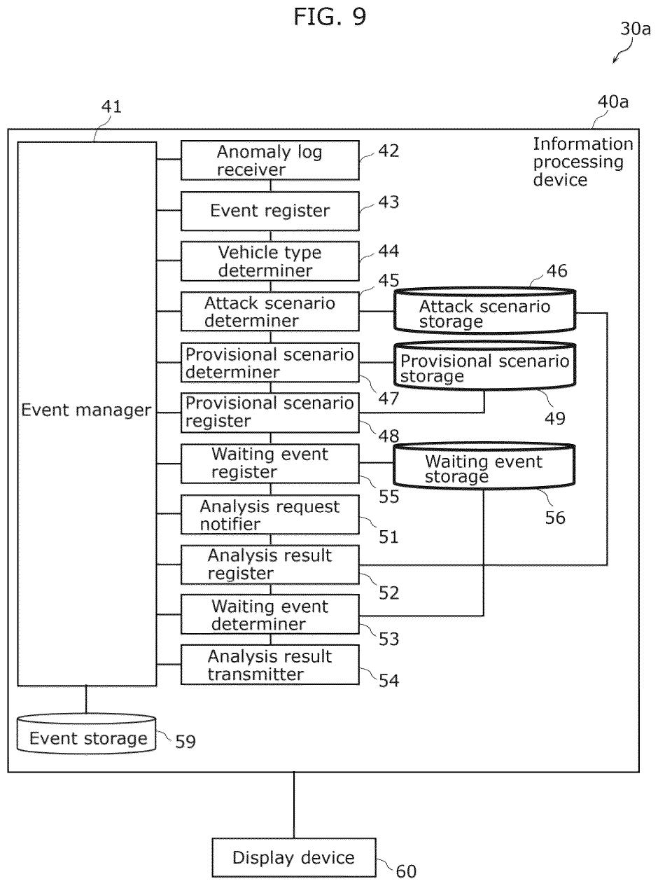

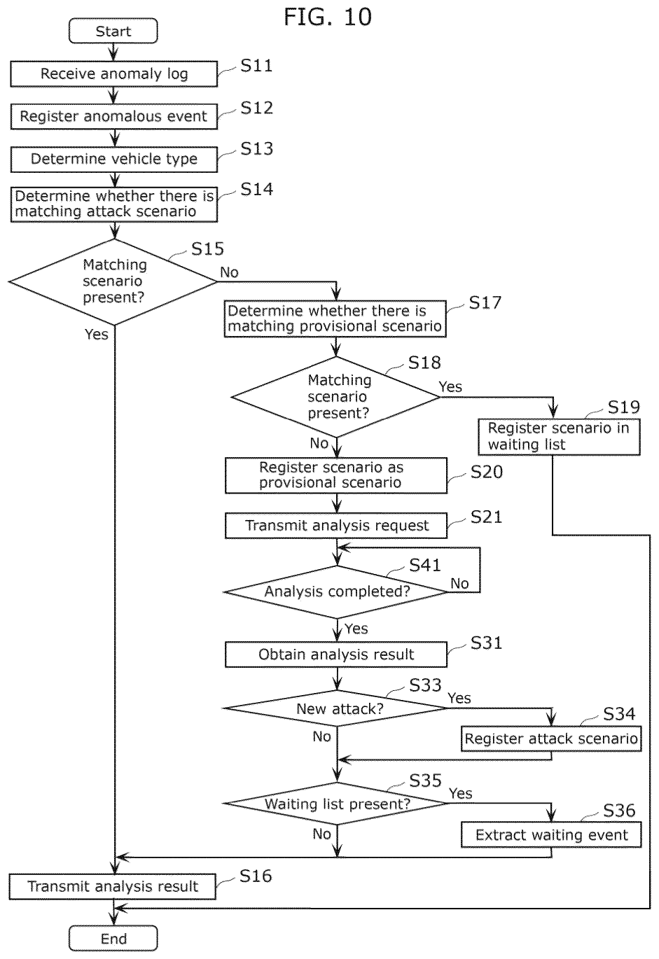

An information processing device according to the present embodiment is described with reference to FIG. 9 and FIG. 10.

### [2-1. Configuration of Information Processing Device]

FIG. 9 is a block diagram illustrating a functional configuration of information processing system 30a according to the present embodiment.

As illustrated in FIG. 9, information processing system 30a includes information processing device 40a and display device 60.

Information processing device 40a is different from information processing device 40 according to Embodiment 1 in that waiting event register 55 and waiting event storage 56 are included.

Waiting event register 55 stores an event ID of a waiting event in waiting event storage 56.

Waiting event storage 56 stores an event ID of a waiting event. For example, the waiting event corresponds to a waiting list described in Embodiment 1. Waiting event storage 56 is implemented by a semiconductor memory, for example. However, this is not intended to be limiting.

### [2-2. Operation of Information Processing Device]

Next, an operation of information processing device 40a having the above configuration is described with reference to FIG. 10. FIG. is a flowchart illustrating an operation (an information processing method) performed by information processing device 40a according to the present embodiment. Note that FIG. 10 illustrates the operation performed by information processing device 40a that does not include waiting event determiner 53.

The flowchart according to the present embodiment illustrated in FIG. 10 is substantially a combination of the flowchart illustrated in FIG. 3 and the flowchart illustrated in FIG. 6.

As illustrated in FIG. 10, after the analysis request is transmitted (S21), information processing device 40a determines whether the analysis of the anomalous event that is a source for the third attack scenario indicating the anomaly detail that matches the first attack scenario is completed (S41). Information processing device 40a may make the determination in Step S41 by determining whether notification about the completion of the analysis has been received. When the result of the determination is “Yes” in Step S41, the subsequent processes are the same as those in FIG. 6 and thus descriptions thereof are omitted here. When the result of the determination is “No” in Step S41, information processing device 40a waits until the completion of the analysis.

### Embodiment 3

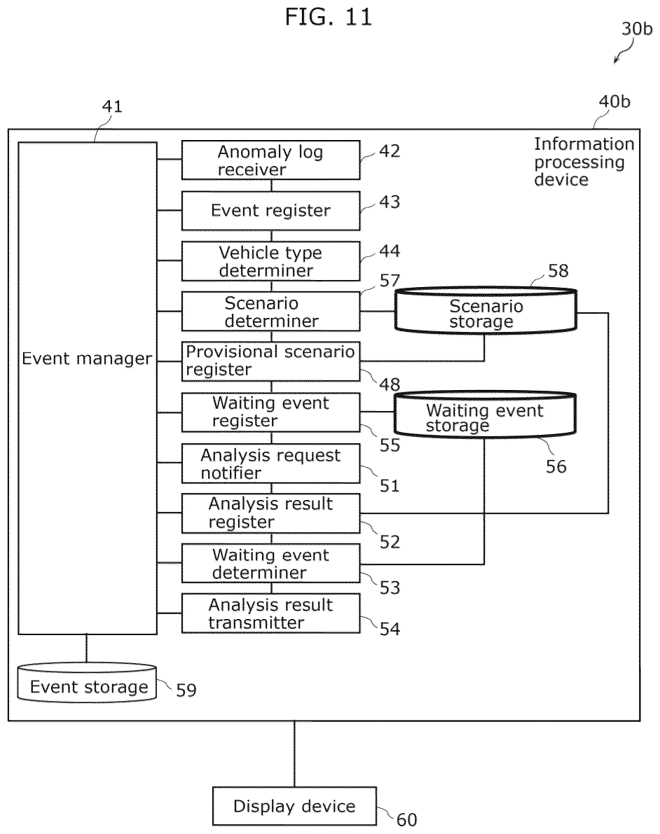

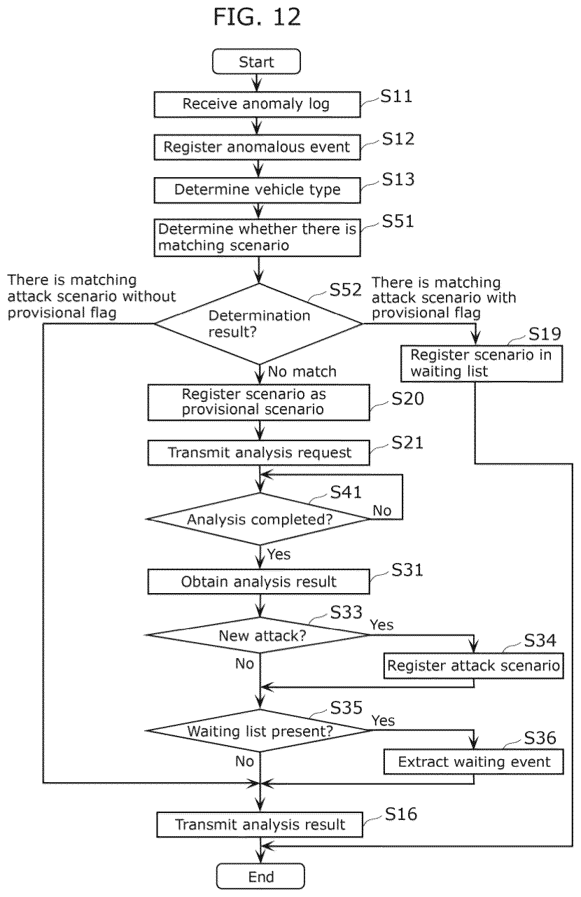

An information processing device according to the present embodiment is described with reference to FIG. 11 and FIG. 12.

### [3-1. Configuration of Information Processing Device]

FIG. 11 is a block diagram illustrating a functional configuration of information processing system 30b according to the present embodiment.

As illustrated in FIG. 11, information processing system 30b includes information processing device 40b and display device 60. Information processing device 40b includes scenario determiner 57 in place of attack scenario determiner 45 and provisional scenario determiner 47 of information processing device 40a according to Embodiment 2. Furthermore, information processing device 40b includes scenario storage 58 in place of attack scenario storage 46 and provisional scenario storage 49.

Scenario determiner 57 performs a single determination process to make the determinations made by attack scenario determiner 45 and provisional scenario determiner 47 illustrated in FIG. 9 according to Embodiment 2.

Scenario storage 58 stores a list (a combined scenario list) including a second attack scenario and a third attack scenario. The combined scenario list includes both the second attack scenario and the third attack scenario. In this list according to the present embodiment, a flag is added only to the third attack scenario, among the second attack scenario and the third attack scenario. More specifically, an attack scenario among a plurality of attack scenarios included in this list can be identified as a second attack scenario or a third attack scenario by the presence or absence of the flag.

Scenario storage 58 is implemented by a semiconductor memory, for example. However, this is not intended to be limiting.

Note that the flag is information for identifying an attack scenario or a provisional scenario and may be added to one of the attack scenario or the provisional scenario.

### [3-2. Operation of Information Processing Device]

Next, an operation of information processing device 40b having the above configuration is described with reference to FIG. 12. FIG. 12 is a flowchart illustrating an operation (an information processing method) performed by information processing device 40b according to the present embodiment. Note that processes in FIG. 12 that are identical to those in FIG. 10 are assigned reference numerals identical to those used in FIG. 10, and thus descriptions thereof are omitted or simplified. With reference to FIG. 12, the case where a provisional flag (an example of the flag) is added to a provisional scenario is described.

As illustrated in FIG. 12, after Step S13, scenario determiner 57 determines whether the first attack scenario of the anomalous event matches an attack scenario included in the combined scenario list stored in scenario storage 58 (S51). More specifically, based on the combined scenario list, scenario determiner 57 determines whether there is an attack scenario that matches the first attack scenario. When there is an attack scenario that matches the first attack scenario, scenario determiner 57 determines whether the provisional flag is added to this attack scenario.

Next, when scenario determiner 57 determines that there is an attack scenario matching the first attack scenario and that the provisional flag is not added to this attack scenario (determines as “There is matching attack scenario without provisional flag” in S52), this means that the first attack scenario is a known attack. Thus, analysis result transmitter 54 transmits, to SIRT server 70, the analysis result of the anomalous event corresponding to the third attack scenario that matches the first attack scenario, as the analysis result of the present first attack scenario (S16).

When scenario determiner 57 determines that there is no attack scenario matching the first attack scenario (determines as “No match” in S52), provisional scenario register 48 registers the first attack scenario as a provisional scenario (S20) and continues the subsequent processes.

When scenario determiner 57 determines that there is an attack scenario matching the first attack scenario and that the provisional flag is added to this attack scenario (determines as “There is matching attack scenario with provisional flag” in S52), this means that the attack scenario similar to the first attack scenario is currently under analysis or waiting to be analyzed. Thus, waiting event register 55 registers the anomalous event corresponding to the first attack scenario in the waiting list (S19).

As described in Steps S51 and S52 in the present embodiment, the determination whether the detection detail of the anomaly indicated by the first attack scenario matches the detection detail of the anomaly indicated by any one of the at least one second attack scenario and the determination whether the detection detail of the anomaly indicated by the first attack scenario matches the detection detail of the anomaly indicated by any one of the at least one third attack scenario are made by the single determination process using the combined scenario list. For example, when the provisional flag is added to the at least one third attack scenario, scenario determiner 57 causes the anomalous event corresponding to the first attack scenario to wait to be analyzed when the flag is added to an attack scenario that matches the first attack scenario among the at least one second attack scenario and the at least one third attack scenario included in the combined attack scenario list.

### Other Embodiments

Although the information processing method and the like according to one or more aspects of the present disclosure has been described based on embodiments, the present disclosure is not limited to the embodiments. Those skilled in the art will readily appreciate that embodiments arrived at by making various modifications to the above embodiments or embodiments arrived at by selectively combining elements disclosed in the above embodiments without materially departing from the scope of the present disclosure may be included within one or more aspects of the present disclosure.

Although the mobile body is, for example, a vehicle in the embodiments described above, this is not intended to be limiting. The mobile body may be a robot that provides delivery for instance, an air vehicle like a drone, or a train, for example.

In the embodiments described above, the respective lists of the at least one second attack scenario and the at least one third attack scenario are made. However, these attack scenarios need not be listed.

In the embodiments described above, the analysis result is transmitted to SIRT server 70. However, instead of such transmission, the information processing system may store the analysis result by, for example, recording the analysis result in an event storage. In this case, the SIRT server, for instance, may reference to the analysis result by accessing the information processing system.

Each of the elements in each of the above embodiments may be configured in the form of an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory.

The order of steps in each flowchart is an example for explaining the present disclosure in more detail. The order of steps may be changed, or a part of the steps may be performed simultaneously with (in parallel to) another part of the steps. It is also possible to skip a part of the steps.

The dividing of the functional blocks in each of the block diagrams is one example. It is possible that a plurality of functional blocks are implemented into a single functional block, that a single functional block is divided into a plurality of functional blocks, and that a function executed by a functional block is partially executed by another functional block. Furthermore, similar functions of a plurality of functional blocks may be executed by a single hardware or software in parallel or by time division.

The information processing device according to each of the above-described embodiments may be implemented to a single device or include a plurality of devices. If the information processing device includes a plurality of devices, the way of allocating the constituent elements included in the information processing device to the plurality of devices is not limited. For example, at least a part of functions of the constituent elements include in information processing device may be included in a vehicle or a different server. If the information processing device includes a plurality of devices, a communication method between the plurality of devices is not limited. The communication method may be wireless communication or wired communication. It is also possible to combine wireless communication and wired communication between the plurality of devices.

Each constituent element described in the above embodiments may be implemented to software, or typically implemented into a Large Scale Integration (LSI) which is an integrated circuit. These may be integrated separately, or a part or all of them may be integrated into a single chip. Note that here, the terminology “system LSI circuit” is used, but depending on the degree of integration, the circuit may also refer to as IC, LSI circuit, super LSI circuit, or ultra LSI circuit. Moreover, the method of circuit integration is not limited to LSI. Integration may be realized with a specialized circuit or a general purpose processor. After the LSI circuit is manufactured, a field programmable gate array (FPGA) or a reconfigurable processor capable of reconfiguring the connections and settings of the circuit cells in the LSI circuit may be used. Further, if an integrated circuit technology that replaces LSI emerges from advances in or derivations of semiconductor technology, integration of functional blocks using such technology may also be used.

The system LSI is a super multi-function LSI that is a single. chip into which a plurality of constituent elements are integrated. More specifically, the system LSI is a computer system including a microprocessor, a Read Only Memory (ROM), a Random Access Memory (RAM), and the like. The ROM holds a computer program. The microprocessor operates according to the computer program, thereby causing the system LSI to execute its functions.

An aspect of the present disclosure may be a computer program for causing a computer to execute each characteristic step included in the information processing method which is presented in any of FIGS. 4, 6, 8, 10, and 12.

For example, the present disclosure may be implemented to a program that causes the computer to execute the above-described processing. Furthermore, an aspect of the present disclosure may be implemented to a non-transitory computer-readable recording medium storing such a program. For example, such a program may be recorded on a recording medium and distributed. For example, the distributed program may be installed in a device including a different processor, and cause the processor to execute the program, thereby causing the device to perform the above processing.

The following describes the features of the information processing method, the information processing system, and the program which have been described according to the above embodiments.

### Technique 1

An information processing method executed by an information processing system that analyzes an attack scenario by obtaining anomaly logs detected by a plurality of mobile bodies, the information processing method comprising:
obtaining, from one mobile body among the plurality of mobile bodies, an anomaly log indicating an anomaly of the one mobile body; and
when (i) a detection detail of the anomaly included in the anomaly log and indicated by a first attack scenario does not match a detection detail of an anomaly indicated by any one of at least one second attack scenario that has been analyzed and (ii) the detection detail of the anomaly indicated by the first attack scenario matches a detection detail of an anomaly indicated by a third attack scenario among at least one third attack scenario that has not yet been analyzed,
performing a process for the anomaly log as a first anomalous event occurring to the one mobile body, after waiting until the third attack scenario has been analyzed.

### Technique 2

The information processing method according to Technique 1,
wherein, when an analysis result of analyzing the third attack scenario is obtained during the waiting, the performing includes, as the process, outputting the analysis result of the third attack scenario as an analysis result of the first anomalous event.

### Technique 3

The information processing method according to Technique 1,
wherein, when an analysis result of analyzing the third attack scenario that matches the first attack scenario is obtained during the waiting, the performing includes, as the process, determining whether the detection detail of the anomaly indicated by the third attack scenario analyzed matches the detection detail of the anomaly included in the anomaly log.

### Technique 4

The information processing method according to Technique 3,
wherein, when the detection detail of the anomaly indicated by the third attack scenario analyzed does not match the detection detail of the anomaly indicated by the first attack scenario, the performing includes determining whether the detection detail of the anomaly indicated by the first attack scenario matches a detection detail of an anomaly indicated by at least one of: at least one latest second attack scenario; or at least one latest third attack scenario.

### Technique 5

The information processing method according to any one of Techniques 1 to 4,
wherein, when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes determining that the first anomalous event is to be analyzed.

### Technique 6

The information processing method according to Technique 5,
wherein the at least one third attack scenario is listed in a provisional scenario list, and
when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes adding the first attack scenario to the provisional scenario list.

### Technique 7

The information processing method according to any one of Techniques 1 to 6,
wherein, when the first attack scenario matches a second attack scenario among the at least one second attack scenario,
the performing includes outputting an analysis result of the second attack scenario as an analysis result of the first anomalous event.

### Technique 8

The information processing method according to any one of Techniques 1 to 7, further comprising:
determining a vehicle type of the one mobile body, based on the anomaly log,
wherein in the performing, whether the first attack scenario matches any one of the at least one second attack scenario and whether the first attack scenario matches any one of the at least one third attack scenario are determined based on a result obtained in the determining of the vehicle type.

### Technique 9

The information processing method according to Technique 8,
wherein each of the at least one second attack scenario and the at least one third attack scenario is an attack scenario against a vehicle that is of a same vehicle type as the vehicle type of the one mobile body among the plurality of mobile bodies.

### Technique 10

The information processing method according to any one of Techniques 1 to 9,
wherein the at least one second attack scenario and the at least one third attack scenario are listed in a combined scenario list, and
either the at least one second attack scenario or the at least one third attack scenario includes a flag.

### Technique 11

The information processing method according to Technique 10,
wherein in the performing,
whether the detection detail of the anomaly indicated by the first attack scenario matches the detection detail of the anomaly indicated by any one of the at least one second attack scenario and whether the detection detail of the anomaly indicated by the first attack scenario matches the detection detail of the anomaly indicated by any one of the at least one third attack scenario are determined by a single determination using the combined scenario list.

### Technique 12

The information processing method according to Technique 10 or 11,
wherein in the performing,
in a case where the at least one third attack scenario includes the flag, when the flag is added to an attack scenario that indicates a detection detail of an anomaly that matches the detection detail of the anomaly indicated by the first attack scenario, among the at least one second attack scenario and the at least one third attack scenario included in the combined scenario list,
analyzing of the first anomalous event is performed after the waiting.

### Technique 13

The information processing method according to any one of Techniques 1 to 12,
wherein the performing includes:
adding, to a waiting list, the first anomalous event for which the performing of the process is to be waited; and
presenting presentation information based on the waiting list.

### Technique 14

The information processing method according to Technique 13,
wherein the presentation information includes information indicating, out of a plurality of the first anomalous events included in the waiting list, a total number of first anomalous events determined to match the detection detail of the anomaly included in the at least one third attack scenario.

### Technique 15

The information processing method according to any one of Techniques 1 to 14,
wherein, when an analysis result of a second anomalous event that is a source for a fourth attack scenario included among the at least one third attack scenario is outputted,
the performing includes outputting a total number of anomalous events determined to match a detection detail of an anomaly indicated by the fourth attack scenario when whether the first attack scenario matches any one of the at least one third attack scenario is determined.

### Technique 16

The information processing method according to Technique 7, further comprising:
determining whether an analysis of an anomalous event that is a source for the third attack scenario indicating the anomaly detail matching the first attack scenario is completed.

### Technique 17

An information processing system that analyzes an attack scenario by obtaining anomaly logs detected by a plurality of mobile bodies, the information processing system comprising:

an obtainer that obtains, from one mobile body among the plurality of mobile bodies, an anomaly log indicating an anomaly of the one mobile body; and
a controller that performs,
when (i) a detection detail of the anomaly included in the anomaly log and indicated by a first attack scenario does not match a detection detail of an anomaly indicated by any one of at least one second attack scenario that has already been analyzed and (ii) the detection detail of the anomaly indicated by the first attach scenario matches a detection detail of an anomaly indicated by a third attack scenario among at least one third attack scenario that has not yet been analyzed,
a process for the anomaly log as a first anomalous event occurring to the one mobile body, after waiting until the third attack scenario has been analyzed.

### Technique 18

A non-transitory computer-readable recording medium having recorded thereon a program for causing a computer to execute the information processing method according to any one of Techniques 1 to 16.

### Further Information about Technical Background to this Application

The disclosures of the following patent applications including specification, drawings, and claims are incorporated herein by reference in their entirety: Japanese Patent Application No. 2022-088286 filed on May 31, 2022, and PCT International Application No. PCT/JP2023/003815 filed on Feb. 6, 2023.

### INDUSTRIAL APPLICABILITY

The present disclosure is useful to an information processing method and so forth for analyzing an anomaly occurring to a mobile body.

1. An information processing method executed by an information processing system that analyzes an attack scenario by obtaining anomaly logs detected by a plurality of mobile bodies, the information processing method comprising:
obtaining, from one mobile body among the plurality of mobile bodies, an anomaly log indicating an anomaly of the one mobile body; and
when (i) a detection detail of the anomaly included in the anomaly log and indicated by a first attack scenario does not match a detection detail of an anomaly indicated by any one of at least one second attack scenario that has been analyzed and (ii) the detection detail of the anomaly indicated by the first attack scenario matches a detection detail of an anomaly indicated by a third attack scenario among at least one third attack scenario that has not yet been analyzed,
performing a process for the anomaly log as a first anomalous event occurring to the one mobile body, after waiting until the third attack scenario has been analyzed.

2. The information processing method according to claim 1,
wherein, when an analysis result of analyzing the third attack scenario is obtained during the waiting, the performing includes, as the process, outputting the analysis result of the third attack scenario as an analysis result of the first anomalous event.

3. The information processing method according to claim 1,
wherein, when an analysis result of analyzing the third attack scenario that matches the first attack scenario is obtained during the waiting, the performing includes, as the process, determining whether the detection detail of the anomaly indicated by the third attack scenario analyzed matches the detection detail of the anomaly included in the anomaly log.

4. The information processing method according to claim 3,
wherein, when the detection detail of the anomaly indicated by the third attack scenario analyzed does not match the detection detail of the anomaly indicated by the first attack scenario, the performing includes determining whether the detection detail of the anomaly indicated by the first attack scenario matches a detection detail of an anomaly indicated by at least one of: at least one latest second attack scenario; or at least one latest third attack scenario.

5. The information processing method according to claim 1,
wherein, when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes determining that the first anomalous event is to be analyzed.

6. The information processing method according to claim 5,
wherein the at least one third attack scenario is listed in a provisional scenario list, and
when the detection detail of the anomaly indicated by the first attack scenario does not match either the detection detail of the anomaly indicated by any one of the at least one second attack scenario or the detection detail of the anomaly indicated by any one of the at least one third attack scenario, the performing includes adding the first attack scenario to the provisional scenario list.

7. The information processing method according to claim 1,
wherein, when the first attack scenario matches a second attack scenario among the at least one second attack scenario,
the performing includes outputting an analysis result of the second attack scenario as an analysis result of the first anomalous event.

8. The information processing method according to claim 1, further comprising:
determining a vehicle type of the one mobile body, based on the anomaly log,
wherein in the performing, whether the first attack scenario matches any one of the at least one second attack scenario and whether the first attack scenario matches any one of the at least one third attack scenario are determined based on a result obtained in the determining of the vehicle type.

9. The information processing method according to claim 8,
wherein each of the at least one second attack scenario and the at least one third attack scenario is an attack scenario against a vehicle that is of a same vehicle type as the vehicle type of the one mobile body among the plurality of mobile bodies.

10. The information processing method according to claim 1,
wherein the at least one second attack scenario and the at least one third attack scenario are listed in a combined scenario list, and
either the at least one second attack scenario or the at least one third attack scenario includes a flag.

11. The information processing method according to claim 10,
wherein in the performing,
whether the detection detail of the anomaly indicated by the first attack scenario matches the detection detail of the anomaly indicated by any one of the at least one second attack scenario and whether the detection detail of the anomaly indicated by the first attack scenario matches the detection detail of the anomaly indicated by any one of the at least one third attack scenario are determined by a single determination using the combined scenario list.

12. The information processing method according to claim 10,
wherein in the performing,
in a case where the at least one third attack scenario includes the flag, when the flag is added to an attack scenario that indicates a detection detail of an anomaly that matches the detection detail of the anomaly indicated by the first attack scenario, among the at least one second attack scenario and the at least one third attack scenario included in the combined scenario list,
analyzing of the first anomalous event is performed after the waiting.

13. The information processing method according to claim 1,
wherein the performing includes:
adding, to a waiting list, the first anomalous event for which the performing of the process is to be waited; and
presenting presentation information based on the waiting list.

14. The information processing method according to claim 13,
wherein the presentation information includes information indicating, out of a plurality of the first anomalous events included in the waiting list, a total number of first anomalous events determined to match the detection detail of the anomaly included in the at least one third attack scenario.

15. The information processing method according to claim 1,
wherein, when an analysis result of a second anomalous event that is a source for a fourth attack scenario included among the at least one third attack scenario is outputted,
the performing includes outputting a total number of anomalous events determined to match a detection detail of an anomaly indicated by the fourth attack scenario when whether the first attack scenario matches any one of the at least one third attack scenario is determined.

16. The information processing method according to claim 7, further comprising:
determining whether an analysis of an anomalous event that is a source for the third attack scenario indicating the anomaly detail matching the first attack scenario is completed.

17. An information processing system that analyzes an attack scenario by obtaining anomaly logs detected by a plurality of mobile bodies, the information processing system comprising:
an obtainer that obtains, from one mobile body among the plurality of mobile bodies, an anomaly log indicating an anomaly of the one mobile body; and
a controller that performs,
when (i) a detection detail of the anomaly included in the anomaly log and indicated by a first attack scenario does not match a detection detail of an anomaly indicated by any one of at least one second attack scenario that has already been analyzed and (ii) the detection detail of the anomaly indicated by the first attach scenario matches a detection detail of an anomaly indicated by a third attack scenario among at least one third attack scenario that has not yet been analyzed,
a process for the anomaly log as a first anomalous event occurring to the one mobile body, after waiting until the third attack scenario has been analyzed.

18. A non-transitory computer-readable recording medium having recorded thereon a program for causing a computer to execute the information processing method according to claim 1.
